(19) United States
(12) Patent Application Publication
(10) Pub. No.: US 2019/0050438 A1
(43) Pub. Date: Feb. 14, 2019

(54) SYSTEM AND METHOD FOR UPDATING INFORMATION

(71) Applicant: Thomas James Fast, Norwalk, CT (US)

(72) Inventor: Thomas James Fast, Norwalk, CT (US)

(21) Appl. No.: 16/059,961

(22) Filed: Aug. 9, 2018

Related U.S. Application Data
(60) Provisional application No. 62/543,252, filed on Aug. 9, 2017.
(60) Provisional application No. 62/543,273, filed on Aug. 9, 2017.

(51) Int. Cl. G06F 17/30; H04L 12/58; H04L 29/08

(52) U.S. Cl. CPC G06F 17/30345; G06F 17/30867; H04L 51/32; G06F 15/18; H04L 67/1044; H04L 67/26; H04L 51/20

(57) ABSTRACT

An information update system is disclosed. The information update system has an information update module, comprising computer-executable code stored in non-volatile memory, a processor, and a hub component. The information update module, the processor, and the hub component are configured to establish data transfer connections between one or more data publishers and one or more data subscribers, set permissions for the one or more data subscribers based on input from the one or more data publishers, receive information update data from the one or more data publishers, and transfer the information update data to the one or more data subscribers based on the permissions. The information update data includes an account information update or a contact information update of the one or more data publishers.

### RELATED APPLICATIONS

This application claims the benefit of U.S. provisional patent application 62/543,252 filed Aug. 9, 2017, and U.S. provisional patent application 62/543,273 filed Aug. 9, 2017, which are hereby incorporated by reference in their entirety.

### TECHNICAL FIELD

The present disclosure generally relates to a system and method for updating information, and more particularly to a system and method for updating account and contact information.

### BACKGROUND

Individual users typically manage a few dozen different computer accounts including utilities, social media, bank accounts, loyalty accounts, education accounts, work accounts, online and/or mobile applications, and other types of accounts. Additionally, individuals typically provide their contact information on forms and to personal and professional contacts many times per year. Updating accounts, service providers, and contacts is a burdensome process when an individual moves, switches companies, and/or changes contact information. Most people struggle to remember all of their accounts or login credentials to update information.

Payment data is a form of account information that tends to be more dynamic relative to other account information. A primary spending account may change for example when a user opens a new account, an old credit card is lost, an account is cancelled, a payment device expires, or when there is a data breach that leads to card replacement. In each of these cases in which spending details change, a user typically has to update dozens of utility and service accounts.

While social media has provided people with a way to get back in touch with lost contacts, traditional contact information, including payment data, is often not available and rarely exportable to everyday address utilities.

Another issue with the broad distribution of contact information is the challenge of unsubscribing or removing contact data from databases.

The exemplary disclosed system and method are directed to overcoming one or more of the shortcomings set forth above and/or other deficiencies in existing technology.

### SUMMARY OF THE DISCLOSURE

In one exemplary aspect, the present disclosure is directed to an information update system. The information update system includes an information update module, comprising computer-executable code stored in non-volatile memory, a processor, and a hub component. The information update module, the processor, and the hub component are configured to establish data transfer connections between one or more data publishers and one or more data subscribers, set permissions for the one or more data subscribers based on input from the one or more data publishers, receive information update data from the one or more data publishers, and transfer the information update data to the one or more data subscribers based on the permissions. The information update data includes an account information update or a contact information update of the one or more data publishers.

In another aspect, the present disclosure is directed to a method. The method includes establishing data transfer connections via a hub component between one or more data publishers and one or more data subscribers, setting permissions for the one or more data subscribers based on input from the one or more data publishers, receiving information update data from the one or more data publishers, and transferring the information update data to the one or more data subscribers based on the permissions. The information update data includes an account information update or a contact information update of the one or more data publishers.

### BRIEF DESCRIPTION OF THE DRAWINGS

FIG. 1 is a schematic illustration of an exemplary system of the present invention;

FIG. 2 is a schematic illustration of an exemplary system of the present invention;

FIG. 3 is a schematic illustration of an exemplary system of the present invention;

FIG. 4 is a schematic illustration of an exemplary system of the present invention;

FIG. 5 is a schematic illustration of an exemplary system of the present invention;

FIG. 6 is a schematic illustration of an exemplary system of the present invention;

FIG. 7 illustrates an exemplary process of the present invention;

FIG. 8 is a schematic illustration of an exemplary computing device, in accordance with at least some exemplary embodiments of the present disclosure; and

FIG. 9 is a schematic illustration of an exemplary network, in accordance with at least some exemplary embodiments of the present disclosure.

### DETAILED DESCRIPTION AND INDUSTRIAL APPLICABILITY

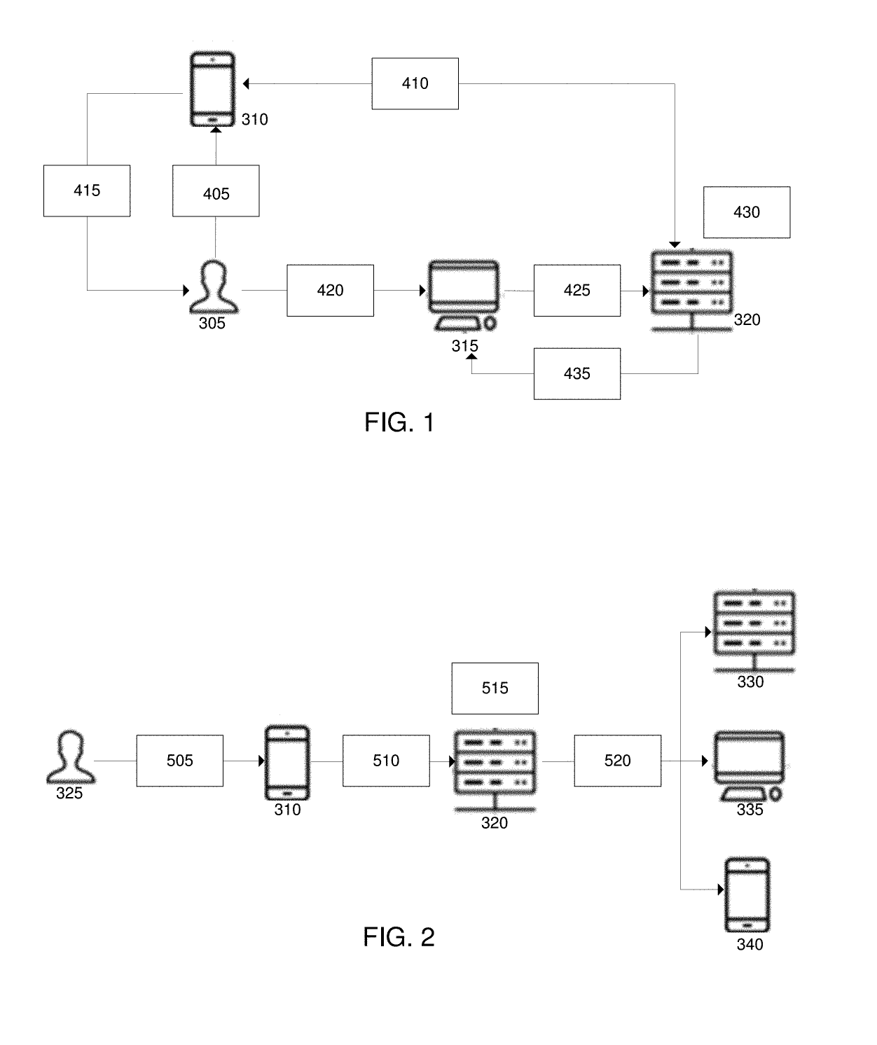

FIGS. 1-4 illustrate an exemplary system for updating information such as account and contact information. The exemplary system may be used for updating information for any suitable account and/or contact information source such as, for example, bank accounts, utility accounts, entertainment and media accounts, social media accounts, loyalty accounts for consumers, education or school accounts, workplace accounts, online or mobile applications, and/or any other type of account or contact information source.

In at least some exemplary embodiments, the exemplary disclosed system may include an arrangement that may have one or more publisher components, a hub component, and one or more subscriber components, and that may provide for efficient updating of account and contact information. The publisher component may be for example a provider of primary user data. The hub component may be for example a central clearing house for data. The subscriber component may be for example a recipient of the data of the hub component. A subscriber may use the subscriber component to subscribe to the system (e.g., to a contact or a user of the system) to receive updates (e.g., future data updates). A contact or a user of the system may use the publishing component to publish the information of that contact or user. For example, the information may be published using the hub component (e.g., using an application to publish using the hub component). The hub component may provide for broad distribution of the information of that contact or user.

In at least some exemplary embodiments, subscribing users (e.g., a plurality of subscribers such as a plurality of users each using a subscribing component) may receive updated contact and account information. Subscribers may receive push updates from the exemplary system. A subscriber (e.g., subscribing user) may be an individual user, a business association such as a company, or any other organization or enterprise. The exemplary system may utilize an application (e.g., an application programming interface or API) or any other suitable delivery system to provide updated data to a subscriber. For example, the exemplary system may make updated data available (e.g., directly available) in a user's (e.g., subscriber's) computing devices, utilities, and/or business systems.

In at least some exemplary embodiments, the exemplary system may provide users such as consumers with substantially full control over their contact or other personal information. Users such as publishers of the exemplary system may be able to selectively disconnect from some or all connections. Users such as subscribers may be able to unsubscribe from some or all connections.

The system may for example include payment functions and/or applications that provide payment or credit to publishers in exchange for their information being published on the system. The system may also include payment functions and/or applications that provide for payment by subscribers in exchange for access to information being published on the system.

In at least some exemplary embodiments, the exemplary system may include suitable tokenization methods that may increase efficiency and/or security for providing contact, personal, and/or payment information (e.g., sensitive financial information such as credit card numbers, PIN numbers, and banking information, as well as social security numbers and/or any other sensitive data). The exemplary system may include applications and/or components that may substitute sensitive data with a non-sensitive identifier that may be mapped to the sensitive data equivalent based on an operation of a tokenization system of the exemplary system. For example, the exemplary tokenization system may be included as part of the hub component. Subscribers such as commercial business associations (e.g., commercial companies) may utilize the tokenization system of the hub component to eliminate the storage of personal data (e.g., personal information of publishers). As opposed to storing personal data of users such as publishers (e.g., consumers), subscribers such as companies may utilize the hub component to provide select information (e.g., tokenized information) to internal systems of the subscribers and/or authorized third parties. The select information may be provided on-demand to subscribers based on requests or inputs to the system by a given subscriber.

In at least some exemplary embodiments, the exemplary system and method may include a subscribing function, a publishing function, an unsubscribing and/or deleting function, and a sharing function. The exemplary functions, described for example below, may flow through the hub component that may be for example a central hub server.

FIG. 1 illustrates an exemplary subscribing process of the exemplary system. The exemplary system may include a user (e.g., subscriber 305), a computing device 310 (e.g., mobile phone, computer, or other computing device), a server or cloud-based application 315 (e.g., website), and a network server 320 (e.g., central server). An automatic update process may begin with a connection being established between a publisher and subscriber 305. The subscriber connection may be established by any suitable technique. For example, a user may receive and/or generate a code that authorizes transfer of data via the connection. In at least some exemplary embodiments, the code may be issued from end-user applications such as mobile applications or browser plugins. A user (e.g., a data provider such as a publisher or alternatively a subscriber) may be prompted by the system to provide additional verification data such as, for example, a user's last name or a User ID for the system to verify that the code is correct. The exemplary system (e.g., a hub component such as a central hub server, for example, server 320) may then create a connection between subscriber 305 and a publisher for transferring data as appropriate. In at least some exemplary embodiments, the system may use a single code to create contact and account data as described above that may serve as a checkout function and/or as a sign-up form.

Also in at least some exemplary embodiments, subscriber 305 may transfer or pass a code electronically. Exemplary electronic methods include using machine-readable bar codes (e.g., a matrix barcode such as QR), using message links such as texting or email, and/or using short-range device communication (e.g., Bluetooth®). Also for example, using a one-sided connection method may allow subscriber 305 to upload sufficient data (e.g., data associated with the publisher) to verify that a bona fide relationship between subscriber 305 and the publisher exists so that a connection may be authorized by the system. The exemplary system may also send a message to a data owner (e.g., the publisher) to authorize the connection based on a request by the subscriber.

Once a connection is established by the system between subscriber 305 and the publisher, data updates may be transferred or passed from the publisher to subscriber 305. The publisher may permission a subset of his or her information to be accessed by each Subscriber. The publisher may set permissions for each subscriber 305 with which a connection has been established. The publisher may set the various permissions settings (e.g., via a user interface such as a computing device, for example, smartphone or tablet or other computer) by using profiles stored in the publisher's accounts and/or contacts. Exemplary profiles may include friends, acquaintances, colleagues, business contacts, classmates, and/or any other suitable profile.

FIG. 1 illustrates exemplary features of the subscribing process described above. In at least some exemplary embodiments, subscriber 305 (e.g., or another user of the system) may login and request a code from the system at step 405 via computing device 310. Computing device 310 may communicate with server 320 to request and receive a returned code at step 410. Subscriber 305 may receive the returned code as output from computing device 310 at step 415. Subscriber 305 may enter the code and/or other data of a user of the system to application 315 at step 420 (e.g., or via computing device 310). Based on input to application 315 by subscriber 305, application 315 may transfer the code, user data, a subscriber ID, and/or any other suitable data to server 320 at step 425. The system (e.g., a hub component such as server 320) may create a subscriber-publisher connection at step 430. Server 320 may transfer a publisher ID, publisher data, and/or any other suitable user data to application 315 at step 435, which may be received by subscriber 305 as output from application 315.

FIG. 2 illustrates an exemplary publishing process of the exemplary system. When a user (e.g., publisher 325) has new or changed contact or account information, the user may upload that information by any suitable technique (e.g., via a mobile device or web application) to the hub component (e.g., server 320). The information may thereby be passed to the hub component. The hub component (e.g., server 320) may maintain a record of subscriber-to-publisher links and associated permissions that may have been created as described above regarding the exemplary process of FIG. 1. The system may then automatically disperse the new or changed account or contact data to each subscriber 305 with permission granted by publisher 325 to receive that data element (e.g., and to each subscriber 305 that is connected to publisher 325 as described for example above). For example, a user (e.g., publisher 325) may update his or her phone number, and the update may be automatically pushed to his or her subscribing friends, colleagues, accounts, utilities, subscribing companies, and/or any other subscriber. If the same publisher 325 updates his or her primary credit card (or organization or business information if publisher 325 is an organization), the push may be limited to a few accounts such as his or her cell phone or car insurance company. Alternatively for example, some information (e.g., information updates) may require specific sharing steps in which the user (e.g., publisher 325) selects which subscribers may receive the new data. For example, the system may prompt publisher 325 to manually select which subscribers 305 may receive the information. One or more subscribers 305 may choose to pull (e.g., fetch) updates on demand in addition to or as an alternative to having the system send updates in real-time. One or more subscribers 305 may also choose to review any data changes to prevent publishers from providing incorrect or bogus information. Subscribers may also have the ability to backup updated information and/or roll back updates.

The exemplary system may utilize a tokenized method in which payment data may be provided to an intermediary (e.g., such as Stripe, Authorize.net, or any other suitable intermediary) and a billing-company-specific token may be transferred or passed to subscriber 305. If the exemplary system has access to mobile location data (e.g., GPS data), the system may periodically ping a user during various times (e.g., the day or night) to confirm (e.g., establish) a home and/or work location of a given user. The system may also track IP addresses to obtain additional or broader location data. The system may request updated information if this location data materially changes, based on machine learning and/or probability models. In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

FIG. 2 illustrates exemplary features of the subscribing process described above. In at least some exemplary embodiments, publisher 325 (e.g., or another user of the system) may login and provide new or updated account and/or contact information to the system at step 505 via computing device 310. Computing device 310 may communicate with server 320 to transfer publisher ID, new user data including for example updated or new account and contact information, and/or any other suitable data at step 510 to server 320. At step 515, the system (e.g., a hub component such as server 320) may determine (e.g., identify) some or all users subscribing to the publisher ID of publisher 325. At step 520, the system (e.g., a hub component such as server 320) may transfer new user data including for example updated or new account and contact information to some or all authorized subscribers. For example, the exemplary system may transfer new or updated data to subscribers via any suitable technique such as transferring data to a network 330, an application or computing device 335 (e.g., a computer or application), and/or a mobile device 340. For example, the system may push the new or updated information to all subscribers having permission to receive the data. For example, prior to transferring the information, the system may check permissions of some or all subscribers subscribing to the publisher ID to determine is those subscribers have authorization to receive a given new or updated portion of data.

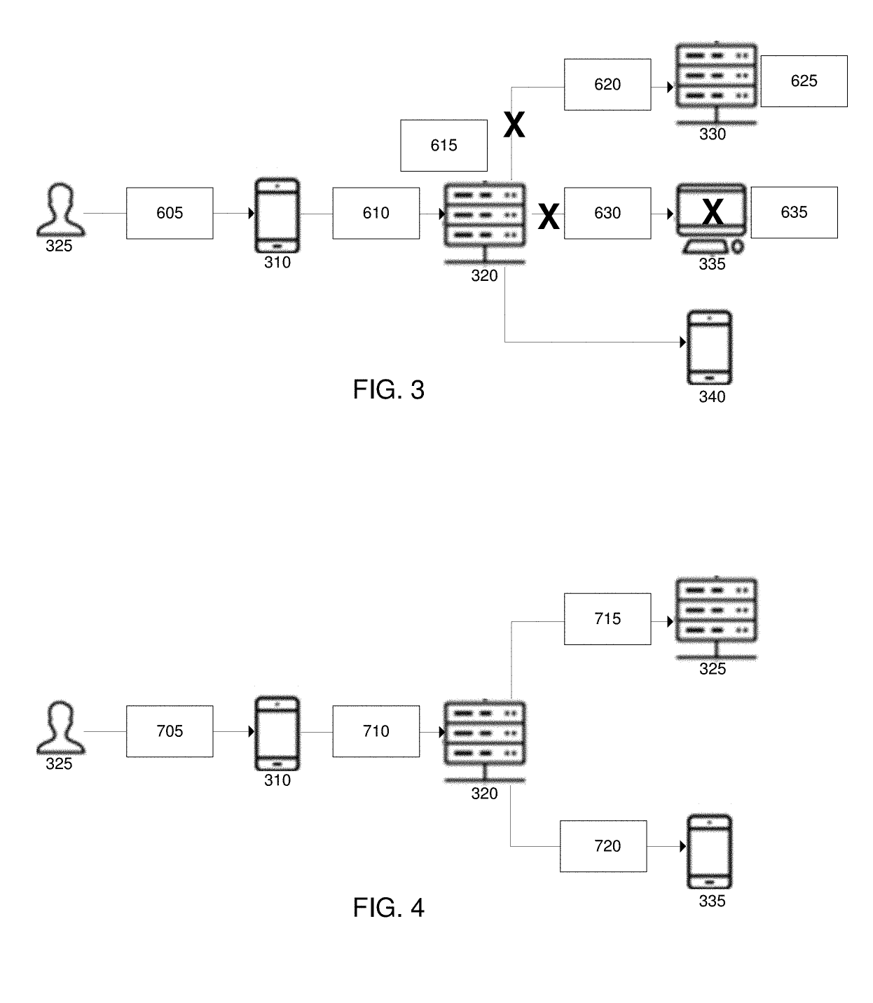

FIG. 3 illustrates an exemplary unsubscribing or deleting process of the exemplary system. In at least some exemplary embodiments, a user (e.g., publisher 325) may opt out of transferring some or substantially all new and/or updated account and contact information to subscribers via the exemplary system. For example, publisher 325 may unsubscribe and/or delete transferred data.

In at least some exemplary embodiments, publisher 325 and/or the exemplary system may unsubscribe a subscriber by removing a connection between publisher 325 and a subscriber 305. Removing the connection may stop any future data updates to that subscriber 305. Removing the connection may for example involve changing connection tokens to prevent a given subscriber from receiving or fetching (e.g., pulling) data from the system. Unsubscribing a subscriber 305 may encompass all future communications and/or data transfers (e.g., updates) or select types of data transfer (e.g., select types of updated and/or new account or contact information). Under the exemplary unsubscribing process, a given subscriber 305 may retain the latest new or updated contact and account information they have received up to the point of being unsubscribed. The unsubscribing process may be used for example when a full system integration has not been implemented, when there is a legitimate reason to retain data, when the updates are used in personal address books, and/or any other suitable situation. Also for example, the unsubscribing process may be used when a given publisher 325 has an account with a subscriber and may owe that subscriber money, or in any other situation where there may be a bona fide reason (e.g., commercial reason and/or legal reason) to retain the data.

In at least some exemplary embodiments, publisher 325 and/or the exemplary system may delete a subscriber. The deleting process may include similar functions as the unsubscribing functions described above, and may also include sending a request to a given subscriber 305 to delete account information that may have been previously provided (e.g., transferred) by a given publisher 325. The deleting process may for example be used when business contact and account connections desire to opt out of future marketing outreach or activities. Subscribers such as business associations may for example still maintain certain data for the purposes of maintaining a “do-not-contact” list.

FIG. 3 illustrates exemplary features of the unsubscribing and/or deleting process described above. In at least some exemplary embodiments, publisher 325 (e.g., or another user of the system) may login, view data and/or connections between publisher 325 and subscribers 305, and/or input data regarding connections to be unsubscribed or deleted at step 605 via computing device 310. Computing device 310 may communicate with server 320 to transfer publisher ID, subscriber IDs, and/or unsubscribe or delete requests at step 610 to server 320. At step 615, the system (e.g., a hub component such as server 320) may determine (e.g., identify) which publisher-subscriber connects to unsubscribe or delete. The system may also determine which publisher-subscriber connections will remain unaffected by the unsubscribing and/or deleting process and may be maintained. For example at step 620, a subscriber connection such as with a network 330 may be unsubscribed as described above. At step 625, a latest account or contact data may be retained based on the unsubscribing process described for example above. Also for example at step 630, a subscriber connection such as with an application or computing device 335 (e.g., a computer or application) may be deleted as described above. At step 635, substantially all account or contact data may be removed based on the deleting process described for example above.

FIG. 4 illustrates an exemplary sharing process of the exemplary system. In at least some exemplary embodiments, users (e.g., publisher 325) may share information with contacts, individuals, organizations, and/or other entities that are not registered with the system (e.g., not registered with a central hub such as server 320 to include system applications and services). Publisher 325 may also control a distribution of data updates to one or more subscribers 305 by manually selecting which subscribers 305 may receive a given new or updated account or contact data. The data may be shared through the exemplary system and/or through any other suitable technique such as texting or email (e.g., for unregistered recipients or contacts). For example for unregistered recipients, a share notification may be a contact information file or a link to view or download new or revised account or contact information. Links to download information may involve a recipient verifying the recipient's identity and/or performing a login process before accessing data.

FIG. 4 illustrates exemplary features of the sharing process described above. In at least some exemplary embodiments, publisher 325 (e.g., or another user of the system) may select recipients such as registered users (e.g., subscribers 305) and/or unregistered entities at step 705 via computing device 310. Computing device 310 may communicate with server 320 to transfer user data such as data of subscribers 305 (e.g., subscriber ID or other identifying data) and/or unregistered recipients (e.g., email, phone, and/or other identifying data) at step 710 to server 320. The system (e.g., a hub component such as server 320) may transfer new or updated account or contact information to users such as select subscribers 305 and/or unregistered recipients. For example at step 715, the exemplary system (e.g., a hub component such as server 320) may transfer new or updated account or contact information to a user such as one or more subscribers 305 (e.g., network 325, a computing device, a mobile device, and/or any other user interface that may be used by a registered subscriber to communicate with the exemplary system). For example at step 720, the exemplary system (e.g., a hub component such as server 320) may transfer new or updated account or contact information to a user such as one or more unregistered recipients (e.g., mobile device 335, a computing device, a network, and/or any other user interface that may be used by an unregistered recipient to communicate with the exemplary system).

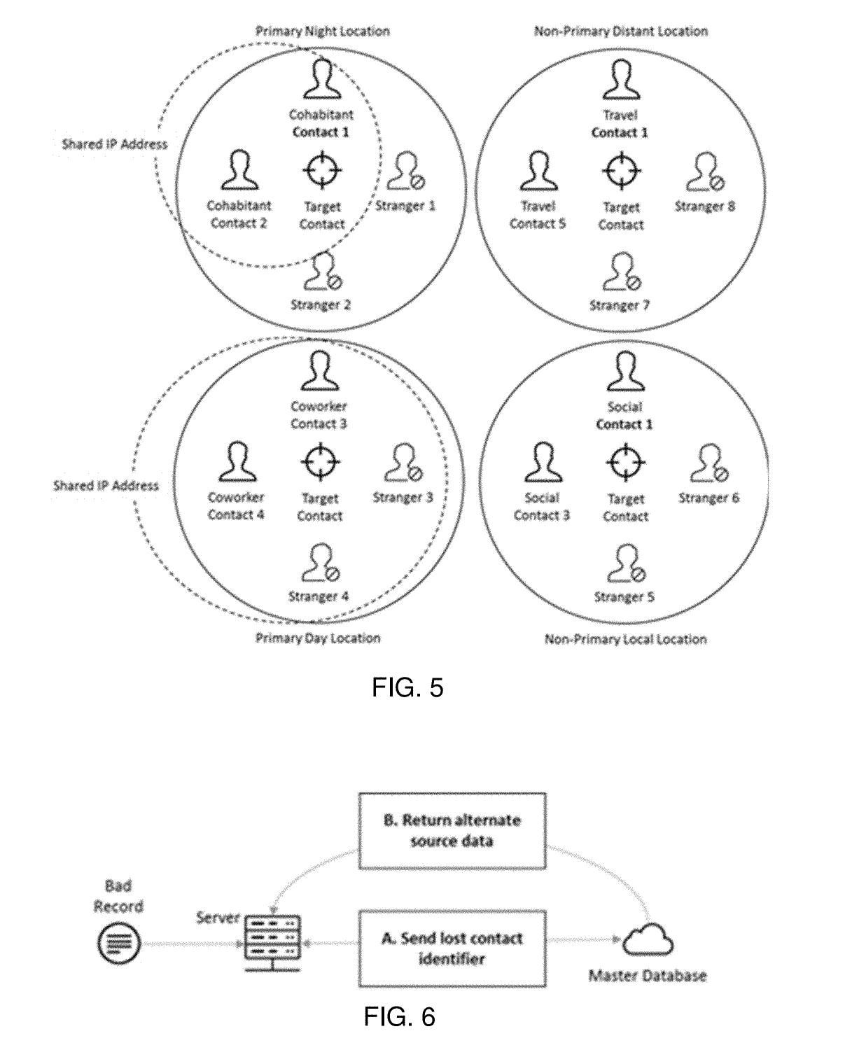

As illustrated in FIG. 5, the exemplary system and method may include a location analysis feature and process (e.g., Geo Social feature) that may provide for analysis of location data to determine social cohorts and changes in location. The exemplary process (e.g., Geo Social method) may involve machine learning and/or probability models (e.g., as described above) to identify “close” contacts. The exemplary process may include gathering typical (e.g. regular or habitual) location-based data such as GPS and other geographic data and determining which contacts (e.g., users such as publishers, subscribers, and/or unregistered recipients) are located in the same or nearby locations. Contacts (e.g., users such as publishers, subscribers, and/or unregistered recipients) may be grouped into cohorts such as, for example, cohabitant/roommate/neighbor, coworker/cotenant, social acquaintances, travel partners, and/or any other desired groupings. The types of cohorts and the frequency of colocation may primarily determine the strength of a given connection among groupings of entities (e.g., publishers, subscribers, and/or unregistered recipients). Shared IP addresses or similar network identifiers may be layered onto this location data, which may be used to identify large office, apartment complex, or other geographic groupings to help segment and group entities. Cross-device linking methods using network data may also be used to add computing devices (e.g., laptop and desktop data) to cohort analysis. The exemplary system may also use location data and building data such as residential or commercial building data to classify locations and the relative strength of a given data point based on that data. For example, an entity (e.g., publisher, subscriber, and/or unregistered recipient) that regularly meets another entity at a restaurant may be assigned more connection value by the system than entities visiting the same large gym or working in the same large structure (e.g., 30-story office building). These connections may also be cross-referenced against social network and/or public record data to confirm relationships. For example, if two entities (e.g., publishers, subscribers, and/or unregistered recipients) are connected on social media and/or have the same small employer based on public data, then their collation may be assigned additional weight by the system. Cross-device linking methods using network data may also be used to add laptop and desktop data. FIG. 5, for example, schematically shows some exemplary embodiments of the process described above.

As illustrated in FIG. 6, the exemplary system and method may include a contact identification process and feature based on maintaining a system of contacts with unique identifiers. For example, the system (e.g., a hub component of the system) may send a unique identifier and/or name to verify account or contact information with a master database of contact records that may be maintained by the system. The unique identifier and/or name may be a record holder specific identifier that may have been previously provided to or provided by a records holder, or a universal identifier that may be maintained by the master database. For example as illustrated in FIG. 6, a lost contact identifier may be sent to the master database. The system may then return the most recent account or contact information (e.g., alternate data) from the master database to the hub component.

In at least some exemplary embodiments, the exemplary information update system may include an information update module, comprising computer-executable code stored in non-volatile memory, a processor, and a hub component (e.g., server 320). The information update module, the processor, and the hub component may be configured to establish data transfer connections between one or more data publishers and one or more data subscribers, set permissions for the one or more data subscribers based on input from the one or more data publishers, receive information update data from the one or more data publishers, and transfer the information update data to the one or more data subscribers based on the permissions. The information update data may include an account information update or a contact information update of the one or more data publishers. The information update module, the processor, and the hub component may be configured to unsubscribe the one or more data subscribers. The information update module, the processor, and the hub component may be configured to unsubscribe the one or more data subscribers and delete the information update data that was transferred to the one or more data subscribers. The information update module, the processor, and the hub component may be configured to analyze location data of the one or more data publishers and one or more data subscribers to determine a social grouping of the one or more data publishers and one or more data subscribers. The information update module, the processor, and the hub component may be configured to assign a connection value to the social grouping based on the location data, social media data, and public record data. The information update module, the processor, and the hub component may be configured to maintain a master database of user contact records and to query the master database of user contact records for most recent contact information of a user. Transferring the information update data to the one or more data subscribers based on the permissions may include pushing the information update data in real-time to the one or more data subscribers. The information update module, the processor, and the hub component may be configured to transfer the information update data to unregistered recipients via texting or email. The hub component may include a tokenization system that tokenizes payment information included in the information update data. The one or more data publishers and the one or more data subscribers may be an individual user and/or a business association. The one or more data publishers and the one or more data subscribers may receive the transferred information update data via a device selected from the group consisting of a mobile phone, a tablet, a computer, and a network server.

The exemplary disclosed system and method may be used in any suitable application involving updating account information and/or contact information. For example, the exemplary system may be used for updating information for any suitable account and/or contact information source such as bank accounts, utility accounts, entertainment and media accounts, social media accounts, loyalty accounts for consumers, education or school accounts, workplace accounts, online or mobile applications, and/or any other type of account or contact information source.

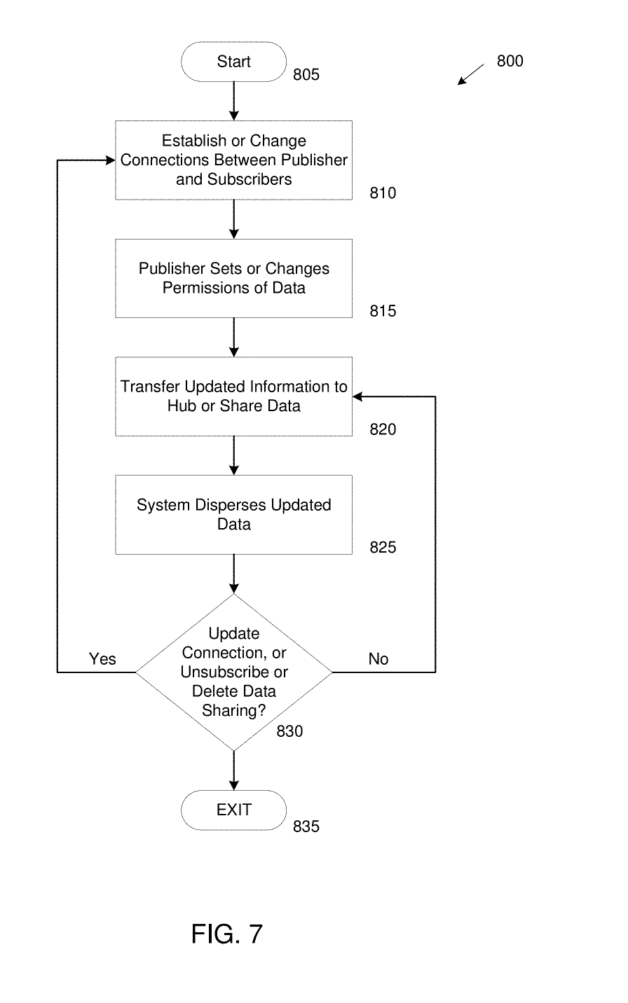

An exemplary operation of the exemplary disclosed system and method will now be described. FIG. 7 illustrates an exemplary process 800 for updating account and contact information. Process 800 starts at step 805. At step 810, the exemplary system may establish, change, and/or update connections between publishers and subscribers as described for example above regarding FIGS. 1 and 2. The publisher may set or change permissions for various subscribers for receiving various types of new or updated account or contact data at step 815 as described above. At step 820, a publisher may transfer information to be published to the hub component as described above regarding FIG. 2. Also for example at step 820, the publisher may share data with select subscribers and/or unregistered recipients as described above regarding FIG. 4. At step 825, the system may transfer (e.g., push or disperse) new or updated account or contact information to subscribers.

At step 830, a publisher may determine whether connections are to be updated or whether an unsubscribing or deleting process is to take place. If these activities are not to take place, the system may return to step 820 and continue to perform steps 820, 825, and 830 as desired. If connections are to be updated and/or an unsubscribing or deleting process is to take place, the exemplary system may return to step 810. A user (e.g., a publisher) may then update connections, perform an unsubscribing process, and/or perform a deleting operation at step 810 as described above. The system may then proceed to steps 815, 820, 825, and 830 as described above. Process 800 may end at step 835.

In at least some exemplary embodiments, the exemplary method may include establishing data transfer connections via a hub component (e.g., server 320) between one or more data publishers and one or more data subscribers, setting permissions for the one or more data subscribers based on input from the one or more data publishers, receiving information update data from the one or more data publishers, and transferring the information update data to the one or more data subscribers based on the permissions. The information update data may include an account information update or a contact information update of the one or more data publishers. The exemplary method may also include receiving a subscriber data from the one or more subscribers and using the subscriber data to validate a relationship between the one or more subscribers and the one or more publishers, and receiving social media account data from the one or more subscribers and using the social media account data to update a profile of the one or more subscribers. The exemplary method may additionally include verifying whether or not the information update data from the one or more publishers is accurate, and blocking further information update data from the one or more publishers if the information update data is not accurate. The exemplary method may also include using daytime or nighttime location data of the one or more subscribers or the one or more publishers to determine if the one or more subscribers or the one or more publishers has changed residential locations or changed jobs. The exemplary method may further include using machine learning or probability models to determine if the one or more subscribers or the one or more publishers has changed residential locations or changed jobs. The exemplary method may additionally include using IP address data of the one or more subscribers or the one or more publishers to determine if the one or more subscribers or the one or more publishers has changed residential locations or changed jobs.

The exemplary disclosed system and method may provide an efficient technique for updating account and contact information. The exemplary disclosed system and method may provide users such as subscribers with accurate, real-time account and contact information when and where such information is desired. The exemplary disclosed system and method may also allow users to avoid the burden of updating numerous accounts and remembering various login credentials for multiple different accounts. The exemplary disclosed system and method may further increase the security of using and transferring sensitive payment information.

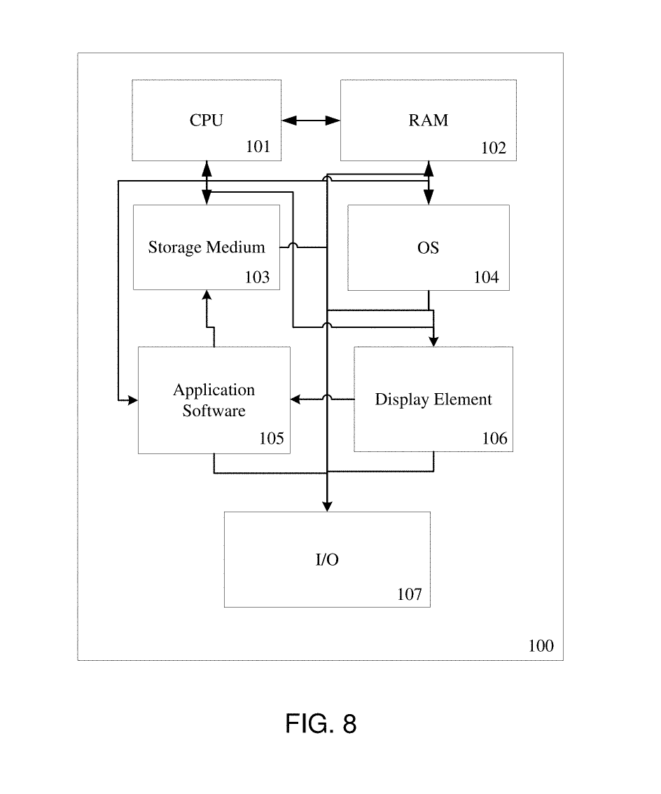

An illustrative representation of a computing device appropriate for use with embodiments of the system of the present disclosure is shown in FIG. 8. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth®, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

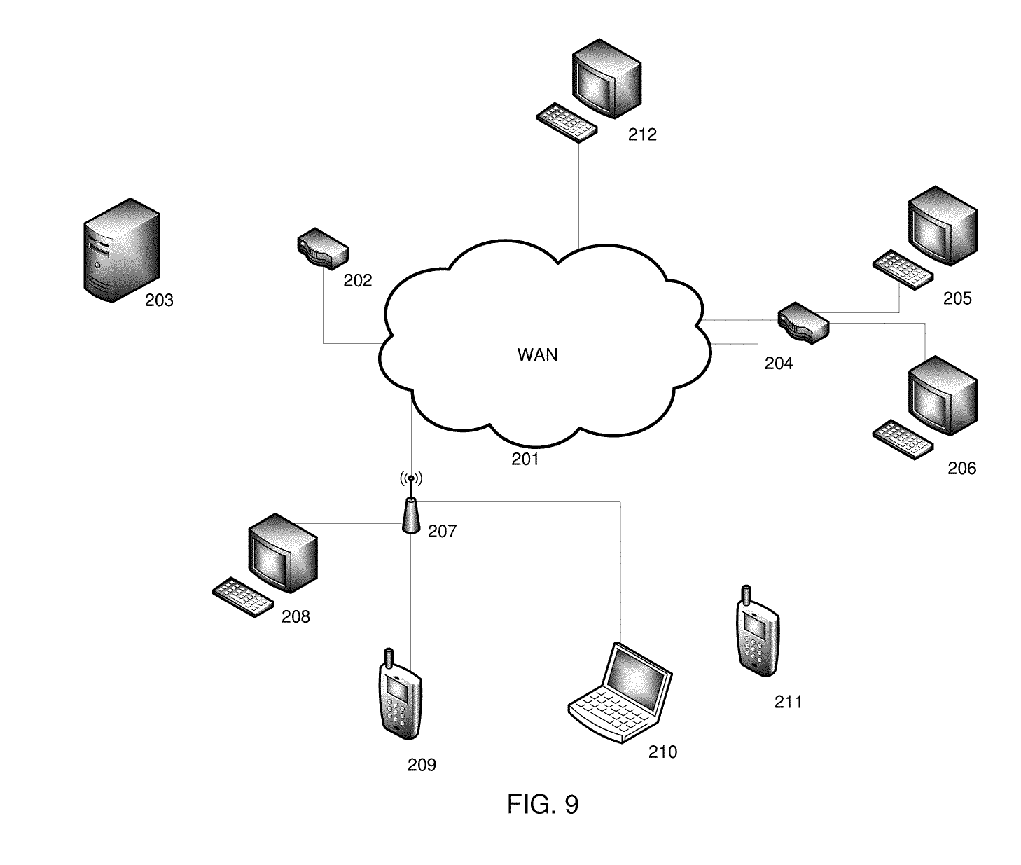

Various examples of such general-purpose multi-unit computer networks suitable for embodiments of the disclosure, their typical configuration and many standardized communication links are well known to one skilled in the art, as explained in more detail and illustrated by FIG. 9, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 9, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 9, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. An information update system, comprising:
an information update module, comprising computer-executable code stored in non-volatile memory;
a processor; and
a hub component;
wherein the information update module, the processor, and the hub component are configured to:
establish data transfer connections between one or more data publishers and one or more data subscribers;
set permissions for the one or more data subscribers based on input from the one or more data publishers;
receive information update data from the one or more data publishers; and
transfer the information update data to the one or more data subscribers based on the permissions;
wherein the information update data includes an account information update or a contact information update of the one or more data publishers.

2. The information update system of claim 1, wherein the information update module, the processor, and the hub component are configured to unsubscribe the one or more data subscribers.

3. The information update system of claim 1, wherein the information update module, the processor, and the hub component are configured to unsubscribe the one or more data subscribers and delete the information update data that was transferred to the one or more data subscribers.

4. The information update system of claim 1, wherein the information update module, the processor, and the hub component are configured to analyze location data of the one or more data publishers and the one or more data subscribers to determine a social grouping of the one or more data publishers and the one or more data subscribers.

5. The information update system of claim 4, wherein the information update module, the processor, and the hub component are configured to assign a connection value to the social grouping based on the location data, a social media data, and a public record data.

6. The information update system of claim 1, wherein the information update module, the processor, and the hub component are configured to maintain a master database of user contact records and to query the master database of user contact records for a most recent contact information of a user.

7. The information update system of claim 1, wherein transferring the information update data to the one or more data subscribers based on the permissions includes pushing the information update data in real-time to the one or more data subscribers.

8. The information update system of claim 1, wherein the information update module, the processor, and the hub component are configured to transfer or gather the information update data to or from unregistered recipients via texting or email.

9. The information update system of claim 1, wherein the hub component includes a tokenization system that tokenizes payment information included in the information update data.

10. The information update system of claim 1, wherein the one or more data publishers and the one or more data subscribers are selected from the group consisting of an individual user and a business association.

11. The information update system of claim 1, wherein the one or more data publishers and the one or more data subscribers receive the transferred information update data via a device selected from the group consisting of a mobile phone, a tablet, a computer, and a network server.

12. A method, comprising:
establishing data transfer connections via a hub component between one or more data publishers and one or more data subscribers;
setting permissions for the one or more data subscribers based on input from the one or more data publishers;
receiving information update data from the one or more data publishers; and
transferring the information update data to the one or more data subscribers based on the permissions;
wherein the information update data includes an account information update or a contact information update of the one or more data publishers.

13. The method of claim 12, further comprising receiving a subscriber data from the one or more subscribers and using the subscriber data to validate a relationship between the one or more subscribers and the one or more publishers.

14. The method of claim 12, further comprising receiving social media account data from the one or more subscribers and using the social media account data to update a profile of the one or more subscribers.

15. The method of claim 12, further comprising verifying whether or not the information update data from the one or more publishers is accurate, and blocking further information update data from one or more publishers if the information update data is not accurate.

16. The method of claim 12, further comprising using daytime or nighttime location data of the one or more subscribers or the one or more publishers to determine if the one or more subscribers or the one or more publishers has changed residential locations or changed jobs.

17. The method of claim 16, further comprising using machine learning or probability models to determine if the one or more subscribers or the one or more publishers has changed residential locations or changed jobs.

18. The method of claim 12, further comprising using IP address or other network data of the one or more subscribers or the one or more publishers to determine if the one or more subscribers or the one or more publishers has changed residential locations or changed jobs.

19. An information update system, comprising:
an information update module, comprising computer-executable code stored in non-volatile memory;
a processor; and
a hub component;
wherein the information update module, the processor, and the hub component are configured to:
establish data transfer connections between one or more data publishers and one or more data subscribers;
set permissions for the one or more data subscribers based on input from the one or more data publishers;
receive information update data from the one or more data publishers;
transfer the information update data to the one or more data subscribers based on the permissions; and
unsubscribe the one or more data subscribers;
wherein the information update data includes an account information update or a contact information update of the one or more data publishers.

20. The information update system of claim 19, wherein the information update module, the processor, and the hub component are configured to delete the information update data that was transferred to the one or more data subscribers.
